(19) United States
(12) Patent Application Publication
(10) Pub. No.: US 2022/0137846 A1
(43) Pub. Date: May 5, 2022

(54) STORAGE HASH VALUES

(71) Applicant: Hewlett-Packard Development Company, L.P., Spring, TX (US)

(72) Inventors: Kang-Ning Feng, Taipei City (TW); Ming Chang Hung, Taipei City (TW); Heng-Fu Chang, Taipei City (TW); Reily Chang, Taipei City (TW)

(73) Assignee: Hewlett-Packard Development Company, L.P., Spring, TX (US)

(21) Appl. No.: 17/419,066

(22) PCT Filed: Jul. 19, 2019
(86) PCT No.: PCT/US2019/042524

§ 371 Date: Jun. 28, 2021

(51) Int. Cl. G06F 3/06

(52) U.S. Cl. CPC G06F 3/0635; G06F 3/0679; G06F 3/0604

(57) ABSTRACT

An example system may include a processor and a non-transitory machine-readable storage medium storing instructions executable by the processer to record, responsive to a first boot of a computing device, storage device identification data and storage device communication path data for a storage device of the computing device, generate a storage device hash value, characterizing a storage configuration of the computing device, from the recorded storage device identification data and the recorded storage device communication path data, and store the storage device hash value to be compared to a subsequently generated storage device hash value characterizing an updated storage configuration of the computing device at a second boot of the computing device.

### BACKGROUND

Computing devices interface with and utilize storage devices in order to perform various operations and/or store data. The storage devices may be communicatively coupled to components of the computing device. A storage configuration may refer to an identity of the storage devices utilized by a computing device and/or a manner in which the storage devices and the components of the computing device are arranged and related to one another. A storage configuration may be modified.

### BRIEF DESCRIPTION OF THE DRAWINGS

FIG. 1 illustrates an example of a system utilizing storage device hash values consistent with the present disclosure.

FIG. 2A illustrates an example of a storage device communication path following a first boot of a computing device utilizable to construct storage device hash values consistent with the present disclosure.

FIG. 2B illustrates an example of a storage device communication path following a second boot of the computing device utilizable to construct storage device hash values consistent with the present disclosure.

FIG. 3 illustrates an example of a process flow diagram for a process of utilizing storage device hash values consistent with the present disclosure.

FIG. 4 illustrates an example of a process flow diagram for a process of utilizing storage device hash values consistent with the present disclosure.

FIG. 5 illustrates an example of a non-transitory machine-readable memory and processor for utilizing storage device hash values consistent with the present disclosure.

FIG. 6 illustrates an example of a method for utilizing storage device hash values consistent with the present disclosure.

### DETAILED DESCRIPTION

Systems may be utilized to detect storage device configuration changes for a computing device. For example, a storage device configuration change detection system may compare storage device configuration data to existing storage device configurations of the computing device. That is, a configuration change may be detected by comparing historical configuration data to updated configuration data for the computing device. For example, a model name or brand name of a storage device communicatively coupled to the computing device may be compared to a stored historical model name or brand name of a storage device communicatively coupled to the computing device.

These systems may utilize such simplistic configuration data to fit within the physical, fiscal, and practical limitations of the storage capacity of a computing device. That is, a storage capacity of a computing device may effectively restrict the amount of data that may be stored to portions of the computing device. For example, a non-volatile random-access memory (NVRAM) component of a computing device may have a limited amount of storage capacity within which storage device configuration data may be stored.

As such, the storage capacity of a computing device may serve as a de facto limit on the amount of detail that can be included in the storage device configuration data. For example, just a model name or brand name of a storage device may be stored as plain text in the NVRAM in order to avoid exceeding the capacity of the NVRAM. In some examples, the fewer details included in the storage device configuration data, the more easily hackable or reverse engineered the storage device configuration data may be. In some examples, the fewer details included in the storage device configuration data, the less of an ability afforded to the computing device and/or its user to detect finer-grained storage device configuration changes (e.g., switching an input/output (I/O) connector port, switching a peripheral component interconnect express (PCIe) bridge, switching a serial ATA (SATA) storage controller connection, changing a component of the storage device, etc.). As such, these finer-grained storage device configuration changes may go unmonitored and/or undetected.

Likewise, the storage capacity of the computing device may impose a de facto limit to the number of storage devices for which storage device configuration data may be stored. As such, such storage device configuration change detection systems may, by virtue of the storage capacity, limit or fix the number of storage devices that the computing device may utilize. Likewise, these storage device configuration change detection systems may, by virtue of the storage capacity, limit or fix the number of storage devices that may be considered in a storage device configuration change detection system for the computing device.

Further, these storage device configuration change detection systems may store storage device configuration data as a plain text describing the storage device configuration data in plain language. However, with plain text descriptions, an unauthorized person or entity may analyze a flash ROM binary dump to reverse engineer and understand the storage device configuration data. In such examples, the unauthorized person or entity may overwrite stored storage device configuration data to add new unauthorized devices that may be utilized to manipulate or control the computing device. As such, this information may allow the unauthorized person or entity to neutralize a storage device configuration change detection system while gaining unauthorized access to the computing device. Additionally, an unauthorized person or entity may utilize the reverse engineered data to build a storage device that may spoof or masquerade as an authorized storage device. Again, the result may be the seamless incorporation of an unauthorized storage device into the computing device that may be utilized to manipulate or control the computing device.

Furthermore, these storage device configuration change detection systems may initially be incompatible with newly introduced technology. That is, when new storage device technology is introduced, the storage device configuration change detection systems may initially lack the ability to interface with and monitor the new technologies. The storage device configuration change detection systems may undergo an update to gain the ability to interface with and monitor storage device configuration data of storage devices with the newly introduced technology

In contrast, examples consistent with the present disclosure may utilize storage device hash values to securely represent comprehensive and detailed storage device configuration data that may be utilized in a storage device configuration change detection operation. Examples consistent with the present disclosure may utilize the storage device hash values to represent comprehensive and detailed storage device configuration data that may be utilized in the storage device configuration change detection operation without straining or exceeding a storage capacity of the computing device reserved for such data.

Likewise, examples consistent with the present disclosure may utilize the storage device hash values to represent comprehensive and detailed storage device configuration data that may be utilized in the storage device configuration change detection operation for an unlimited amount of storage devices. That is, regardless of the amount of storage devices of a computing device that are being considered in the storage device configuration change detection operation, comprehensive and detailed storage device configuration data may be utilized without straining or exceeding a storage capacity of the computing device reserved for such information.

In addition, examples consistent with the present disclosure may utilize the storage device hash values to securely store the storage device configuration data. That is, the storage device configuration data may be stored in a manner that masks its content from potential unauthorized persons or entities. Moreover, the storage device hash values may be generated from storage devices in a manner that supports newly introduced storage device technology without the burden of persistent updating.

Examples consistent with the present disclosure may include a system including a processor and a non-transitory machine-readable medium storing instructions executable by the processor to perform storage device configuration change detection operations utilizing storage device hash values. For example, the system may include instructions executable by the processor to record, responsive to a first boot of a computing device, storage device identification data and storage device path data for a storage device of the computing device. The system may include instructions executable by the processor to generate a hash value, characterizing a storage configuration of the computing device, from the recorded storage device identification data and the recorded storage device path data. The system may include instructions executable by the processor to store the hash value to be compared to a subsequently generated hash value characterizing an updated storage configuration of the computing device at a second boot of the computing device.

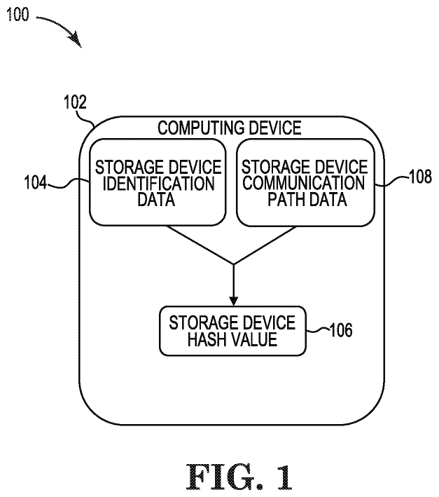

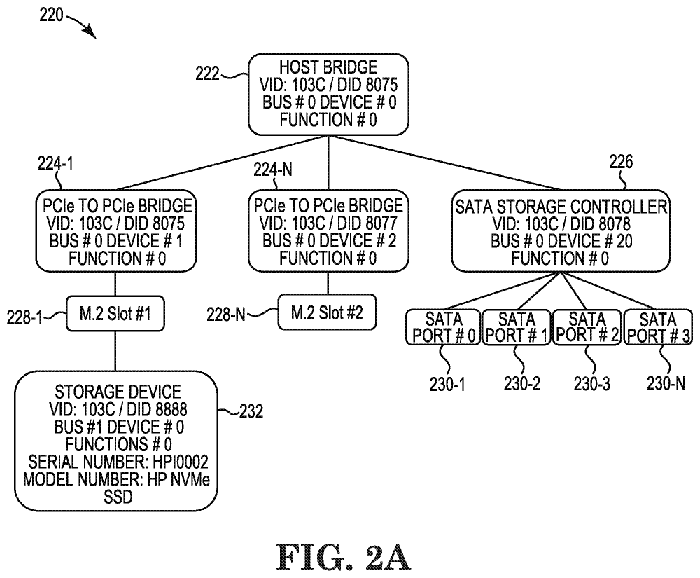

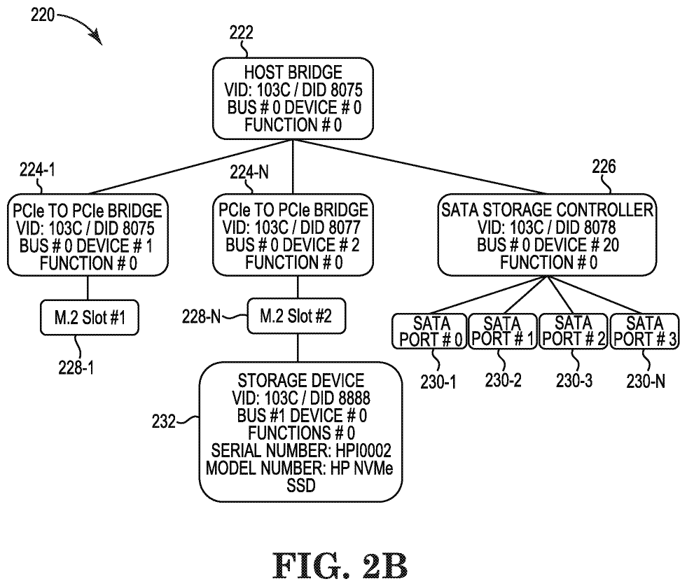

FIG. 1 illustrates an example of a system 100 utilizing storage device hash values consistent with the present disclosure. The described components and/or operations of the system 100 may include and/or be interchanged with the described components and/or operations described in relation to FIG. 2A-FIG. 6.

The system 100 may include a computing device 102. The computing device 102 may include computing components that may be utilized to execute various functions. The computing components of the computing device 102 may be communicably coupled to one another. The computing components may be located within a single chassis or body. Alternatively, the computing components may be distributed across a plurality of chassis or bodies.

The computing components may include a processor, a host controller, a host bridge, a peripheral component interconnect express (PCIe) bridge, a serial ATA (SATA) storage controller, etc. For example, a processor may include a central processing unit (CPU). A host controller may connect with and control communication between the computing device, acting as a host system, and other network and storage devices. A host bridge may include a chip in a core logic chipset architecture of a PC motherboard of a computing device providing a hardware connection between the CPU, host controller, and/or various memory components. A PCIe bridge may include a hardware connection between busses of the computing device. A SATA storage controller may include a hardware and/or software interface that connects a storage hard drive to a computer's motherboard and manages or directs the flow of data.

The computing device 102 may include and/or be communicatively coupled to a storage device. A storage device may include a non-transitory machine-readable medium for storing data. Each storage device may store instructions and/or other data that are accessible to and/or utilizable by the computing device 102. A storage device may include a nonvolatile storage media that persists data, such as a solid-state drive (SSD). In some examples, a storage device may include a SATA SSD, a non-volatile memory express (NVMe) SSD, etc.

In some examples, the storage device may be internal to and/or incorporated within a body of the computing device 102. For example, the storage device may include an internal memory disk such as an NVMe SSD that is part of and/or is installed within a body of the computing device 102. In some examples, the storage device may be external to the computing device 102. For example, the storage device may be an external hard drive, USB flash drive, etc. that is located external from a body of the computing device 102.

A storage device, internal or external, may be communicably coupled to computing components of a computing device 102 via a storage device communication path. For example, a host controller may communicate with a storage device via a storage device communication path. The host controller may access data on a storage device and/or communicate read operations, write operations, etc. to a storage device via a storage device communication path.

A storage device communication path may include a path utilized to communicate commands and/or other data transmissions between, for example, a host controller of a computing device 102 and a storage device. The storage device communication path may be defined by the identity of its constituent components, the arrangement of its constituent components, and/or the hierarchical relationship of its constituent components.

For example, a communication path may include a path from a processor through a host controller, through a host bridge, through a PCI bus, through a PCI bridge, and/or through a SATA storage controller to a storage device. As such, the storage device communication path may be defined by the identity, arrangement, and/or hierarchical relationship between the host controller, the host controller input/output (I/O) port connection pairing, the host bridge, the host bridge I/O port connection pairing, the PCIe bridge, the PCIe bridge I/O port connection pairing, the SATA storage controller, the SATA storage controller I/O port connection pairing, the storage device, the storage device I/O connection pairing, etc.

As mentioned above, the storage device communication path may be defined by a hierarchical arrangement of the constituent components of the storage device communication path and their connections within the computing device. A hierarchical arrangement may refer to a manner in which the components and connections of the storage device communication path may be logically arranged. For example, a component or connection that precedes another in terms of order from the host controller to the storage device, or vice versa, continuously along the storage device communication path may be organized higher in the hierarchy than one that follows it.

A storage device configuration may be modified. For example, an identity, arrangement, and/or hierarchical relationship between components of a storage device communication path may be swapped or rearranged. For example, a host controller may be modified, a host controller input/output (I/O) port connection pairing may be modified, a host bridge may be modified, a host bridge I/O port connection pairing may be modified, a PCIe bridge may be modified, a PCIe bridge I/O port connection pairing may be modified, a SATA storage controller may be modified, a SATA storage controller I/O port connection pairing may be modified, a storage device may be modified, a storage device I/O connection pairing may be modified, etc.

A modification to a storage device configuration may be indicative of an attempt to tamper with the computing device 102. In some examples, a modification to a storage device configuration may be indicative of tampering by a nefarious actor, such as an unauthorized user or entity, attempting to steal data and/or take control of the computing device 102. As such, storage device configuration modifications may be events that a user of a computing device 102 may be made aware of.

The system 100 may utilize a processor and non-transitory machine-readable storage medium storing instructions executable by the processor to detect such modifications to a storage device configuration. In some examples, the instructions may include firmware instructions. The firmware instructions may include boot firmware such as Basic Input/Output System (BIOS) instructions residing on computing device 102. The BIOS instructions may include unified extensible firmware interface (UEFI) specification instructions.

The system 100 may detect the modifications to the storage device configurations by comparison between historical storage device configuration data and updated storage device configuration data responsive to and/or at the time of a boot. As such, storage device configuration data may be stored in a manner that is accessible to the computing device 102 upon boot. The storage device configuration data may be stored in memory, such as non-volatile random-access memory (NVRAM) and/or Flash read-only memory (ROM) as a plain text describing the storage device configuration data in plain language.

In contrast to storage device configuration change detection systems that utilize plain text descriptions of simplistic configuration data, the computing device 102 of system 100 may generate a storage device hash value 106 representation of a storage device configuration for each storage device of the computing device 102. The storage device hash value 106 may be utilized in the comparison between historical storage device configuration data and updated storage device configuration data.

In order to collect the data that will be utilized to generate the storage device hash value 106, the computing device 102 may be scanned. A scan of the computing device 102 may be performed responsive to and/or following a boot of the computing device 102.

The scan may identify any storage devices of the computing device 102. For each of the storage devices identified in the scan, storage device identification data 104 may be collected and/or recorded. Storage device identification data 104 may include a model number of the storage device, a serial number of the storage device, a type of the storage device, a device identification (DID) of the storage device, a vendor identification (VID) of the storage device, a configuration of the storage device, a storage capacity of storage device, and/or other data that may uniquely identify a particular storage device relative to another storage device.

Additionally, for each of the storage devices identified in the scan, storage device communication path data 108 may be collected and/or recorded. Storage device communication path data 108 may include data that describes the storage device communication path between the storage device and components of the computing device 102. In some examples, the storage device communication path data 108 may include data that describes the configuration of the storage device communication path and/or the components of the computing device 102 utilized in the storage device communication path. For example, the storage device path data 108 may include data that describes a model number of a component of the computing device 102 utilized in the storage device communication path, a serial number of a component of the computing device 102 utilized in the storage device communication path, a type of a component of the computing device 102 utilized in the storage device communication path, a DID of a component of the computing device 102 utilized in the storage device communication path, a VID of a component of the computing device 102 utilized in the storage device communication path, a configuration of a component of the computing device 102 utilized in the storage device communication path, and/or other data that may uniquely identify a component of the computing device 102 utilized in the storage device communication path. In some examples, the storage device communication path data 108 may include data that describes an I/O port connection pairing for each I/O port connection in the storage device communication path between a host controller of the computing device 102 and the storage device.

For example, the storage device communication path data 108 may include data describing a DID and/or VID of a bridge in the storage device communication path between a host controller of the computing device 102 and the storage device. Further, the storage device path communication data 108 may include data describing a DID and/or VID of a storage controller in the storage device communication path between the host controller of the computing device 102 and the storage device. Furthermore, the storage device communication path data 108 may include data describing the I/O connector pairings among each of these components in the storage device communication path between the host controller of the computing device 102 and the storage device.

As mentioned above, the storage device communication path may be logically organized as a hierarchical arrangement. That is, the storage device communication path may proceed from a host controller of the computing device 102 to the storage device, or vice versa, as a hierarchically arranged set of connections in the path. As such, the storage device communication path data 108 may include data describing the storage device communication path, where the data is arranged in a hierarchical manner corresponding to the progression of the storage device communication path from the host controller of the computing device 102 to the storage device. For example, the storage device communication path data 108 may include data describing the storage device communication path arranged in a manner where data describing a component, such as an I/O connector pairing and/or other storage device communication path component, that is closest to a host controller of the computing device 102 is organized at a higher level of the hierarchy than those that come later in the storage device communication path closer to the storage device, or vice versa.

As such, the storage device communication path data 108 may include data that provides a comprehensive and detailed description of the hierarchical arrangement, identity, and relationship of each of the constituent components and connections of a storage device communication path. Given their comprehensive and detailed nature, the storage device communication path data 108 and the storage device identification data 104 for each storage device may be a relatively large amount of data. For example, the storage device communication path data 108 and the storage device identification data 104 may consume more storage capacity than is allocated to storage device configuration change detection in the NVRAM of the computing device 102.

However, the storage device communication path data 108 and the storage device identification data 104 for each storage device may be collected by the above described scan and temporarily recorded in a memory buffer of the computing device 102. In some examples, the memory buffer may be a buffer outside of the storage capacity of the NVRAM of the computing device 102 allocated to storage device configuration change detection. In some examples, the memory buffer may be located in volatile memory of the computing device 102.

A storage device hash value 106 may be generated from the recorded storage device communication path data 108 and the storage device identification data 104 for each of the storage devices of the computing device 102. For example, the storage device communication path data 108 and the storage device identification data 104 for each of the storage devices of the computing device 102 that are recorded in the buffer may be processed as inputs through a cryptographic process. The cryptographic process may yield a unique numerical and/or alphanumerical value, or storage device hash value 106, that identifies the contents of and/or validates the storage device communication path data 108 and the storage device identification data 104. For example, the storage device communication path data 108 and the storage device identification data 104 for each of the storage devices of the computing device 102 that are recorded in the buffer may be processed as inputs to a secure hash algorithm (SHA), such as SHA-256. The SHA may yield a unique storage device hash value 106 that identifies the contents of and/or validates the storage device communication path data 108 and the storage device identification data 104.

The generated storage device hash value 106 may uniquely identify the identity, arrangement, and/or relationship of each of the particular constituent components and/or I/O port connection pairings of the storage device communication paths for each of the storage devices of the computing device 102. That is, the storage device hash value 106 may provide a unique value that describes each of the storage devices of the computing device 102 and a storage device communication path between each of those storage devices and a host controller of the computing device 102. In examples where the storage device communication path data 108 and/or the storage device identification data 104 is organized in a hierarchical manner, the storage device hash value 106 may provide a unique value that describes the hierarchical arrangement of each of the storage devices of the computing device 102 within a respective storage device communication path between the corresponding storage device and a host controller of the computing device 102.

Unlike storage device configuration change detection systems that may utilize a plain text description of storage devices, the storage device hash value 106 generated in system 100 may not be feasibly reverse engineered to determine the identity, configuration, and/or arrangement of particular computing device components, storage devices, storage device communication paths, I/O connector port pairings of storage device communication paths, etc. for each of the storage devices of the computing device 102 that it represents. Further, unlike storage device configuration change detection systems that may utilize a plain text description of storage devices, the storage device hash value 106 generated in system 100 may be a value of a fixed length regardless of the amount of data and/or the amount of storage devices which it characterizes. The hash value 106 generated in system 100 may securely represent the identity, arrangement, and/or relationship of particular computing device components, storage devices, storage device communication paths, I/O connector port pairings, etc. present in the storage device communication paths for each of the storage devices of the computing device 102. The hash value may correspond to a moment in time (e.g., following a boot of the computing device 102) when the storage device communication path data 108 and/or the storage device identification data 104. That is, the storage device hash value 106 generated in system 100 may be a secure snapshot or map of the identity, arrangement, and/or relationship of particular computing device components, storage devices, storage device communication paths, I/O connector port pairings, etc. present in the storage device communication paths for each of the storage devices of the computing device 102 following a boot of the computing device 102.

The storage device hash value 106 may be stored. For example, the storage device hash value 106 may be stored on the computing device 102. The storage device hash value 106 may, for example, be written to NVRAM of the computing device 102 accessible to firmware of the computing device 102 upon a subsequent boot. The storage device communication path data 108 and the storage device identification data 104 for each of the storage devices of the computing device 102 stored in the buffer of the computing device 102 may be deleted.

The storage device hash value 106 may be stored for comparison to a subsequently generated storage device hash value characterizing an updated storage device configuration of the computing device 102 upon a subsequent boot of the computing device 102. That is, the storage device hash value 106 may be stored in a manner that it is accessible for a comparison to a subsequently generated storage device hash value. The subsequently generated storage hash value may characterize an identity, arrangement, and/or relationship of particular computing device components, storage devices, storage device communication paths, I/O connector port pairings, etc. present in the storage device communication paths for each of the storage devices of the computing device 102 following a subsequent boot of the computing device 102. Detecting a difference between the stored storage device hash value 106 and the subsequently generated storage device hash value during the comparison may indicate that there has been a storage device configuration change since the previous boot.

Upon each boot, a check may be performed as to whether a storage configuration comparison policy for the computing device 102 is enabled. The storage configuration comparison policy for the computing device 102 may specify whether the generation, storage, and comparison of storage device hash values across boots, as described above, is to occur (e.g., enabled) or not to occur (e.g., disabled). In instances where the storage configuration comparison policy for the computing device 102 is disabled, any stored previously generated hash value characterizing a previous storage device configuration of the computing device 102 may be deleted from the computing device 102. Deleting the previously generated hash value may prevent the proliferation of out-of-date storage device configuration data across multiple boots. In contrast, in instances where the storage configuration comparison policy for the computing device 102 is enabled, a comparison of the generated storage device hash value 106 to a stored previously generated storage device hash value may be performed. Responsive to completing the comparison, the stored previously generated storage device hash value may be overwritten with the more recently generated storage device hash value 106.

FIG. 2A illustrates an example of a storage device communication path 220 following a first boot of a computing device consistent with the present disclosure. FIG. 2B illustrates an example of a storage device communication path 220 following a second boot of the computing consistent with the present disclosure. The described components and/or operations of the storage device communication path 220 may include and/or be interchanged with the described components and/or operations described in relation to FIG. 1 and FIG. 3-FIG. 6.

The storage device communication path 220 may include a host bridge 222 of a computing device. The host bridge 222 may have a VID and a DID assigned to it. The host bridge 222 may have a bus number, a device number, and/or a function number assigned to it.

The storage device communication path 220 may include PCI bridges such as PCIe to PCIe Bridges 224-1 . . . 224-N. Each of the PCIe to PCIe Bridges 224-1 . . . 224-N may have a respective VID and DID assigned to it. Each of the PCIe to PCIe Bridges 224-1 . . . 224-N may have a bus number, a device number, and/or a function number assigned to it. The storage device communication path 220 may also include a slot or port corresponding to each PCI bridge. For example, the storage device communication path 220 may include an M.2 slot #1 228-1 which may correspond to PCIe to PCIe Bridge 224-1, an M.2 slot #2 228-N which may correspond to PCIe to PCIe Bridge 224-N, etc.

The storage device communication path 220 may include a SATA storage controller 226. The SATA storage controller 226 may have a VID and a DID assigned to it. The SATA storage controller 226 may have a bus number, a device number, and/or a function number assigned to it. The storage device communication path 220 may also include ports corresponding to the SATA storage controller 226. For example, the storage device communication path 220 may include SATA ports 230-1 . . . 230-N corresponding to the SATA Storage controller 226.

The storage device communication path 220 may include a storage device 232. The storage device 232 may be one of a plurality of storage devices communicatively coupled to the host bridge 222 of the computing device. The storage device 232 may include non-transitory machine-readable medium accessible to the computing device via a specific communication path.

For example, in FIG. 2A, the host bridge 222 may be communicatively coupled to the storage device 232 via a host bridge 222, to PCIe-to-PCIe 224-1, to M.2 slot #1 228-1, to storage device 232 storage device communication path. As such, the system 100, as described above, may record the storage device identification data and storage device communication path data for the storage device 232 and its corresponding storage device communication path to the host bridge 222. As described above, the storage device identification data and storage device communication path data for the storage device 232 may be stored in a buffer of the computing device. As described above, the storage device identification data and storage device communication path data for the storage device 232 may be stored in a hierarchical arrangement corresponding to the hierarchical organization of the storage device communication path.

For example, in FIG. 2A the storage device identification data and storage device communication path data may be recorded in the following hierarchical manner Level 1: VID:103C/DID:8075/B0 D0 F0, Level 2: 103/C/DID:8076/B0 D1 F0, Level 3: VID:103C/DID:8888/B1 D0 FO/Serial Number: HPI0002/Model Number HP NVMe SSD. This storage device identification data and storage device communication path data may be utilized as an input to generate a storage device hash value of a fixed length. The storage device hash value may be a secure representation of a description of the identity, arrangement, and/or relationship of the particular communication path (e.g., host bridge 222, PCIe to PCIe bridge 224-1, M.2 Slot #1 228-1, storage device 232) for the storage device 232 following a first boot. While the example describes a single storage device 232, additional storage devices may also be added to the buffer and the entire combination of the data for all the storage devices may be hashed to a single storage hash value.

In contrast, in FIG. 2B the storage device identification data and the storage device communication path data may be recorded in the following hierarchical manner: Level 1: VID:103C/DID:8075/B0 D0 F0, Level 2: 103/C/DID:8077/B0 D2 F0, Level 3: VID:103C/DID:8888/B1 D0 FO/Serial Number: HPI0002/Model Number: HP NVMe SSD. The differences in the storage device identification data and the storage device communication path data may reflect the difference in storage device communication path between the two boots.

The storage device identification data and storage device communication path data may be utilized as an input to generate a storage device hash value. The storage device hash value may be of a fixed length, regardless of the amount of data and/or storage devices categorized in the input, and may securely provide a representation of a description of the identity, arrangement, and/or relationship of the particular communication path (e.g., host bridge 222, PCIe to PCIe bridge 224-N, M.2 Slot #2 228-N, storage device 232) for the storage device 232 following a second boot.

The storage device hash value generated at the first boot illustrated in FIG. 2A may be saved at the computing device such that is accessible for comparison to a subsequent storage device hash value generated upon a second boot of the computing device. It may be appreciated that, given the differences between the storage device identification data and the storage device communication path data recorded for the first boot in FIG. 2A and for the second boot in FIG. 2B, utilized as inputs to generate their respective storage device hash value, the resulting storage device hash values will be different. As such, a comparison of the storage device hash value generated upon the second boot, illustrated in FIG. 2B, to the stored storage device hash value previously generated upon the previous first boot illustrated in FIG. 2A will reveal that the two are not equal. A difference between the storage device hash values may indicate that a storage device configuration change has occurred at the computing device.

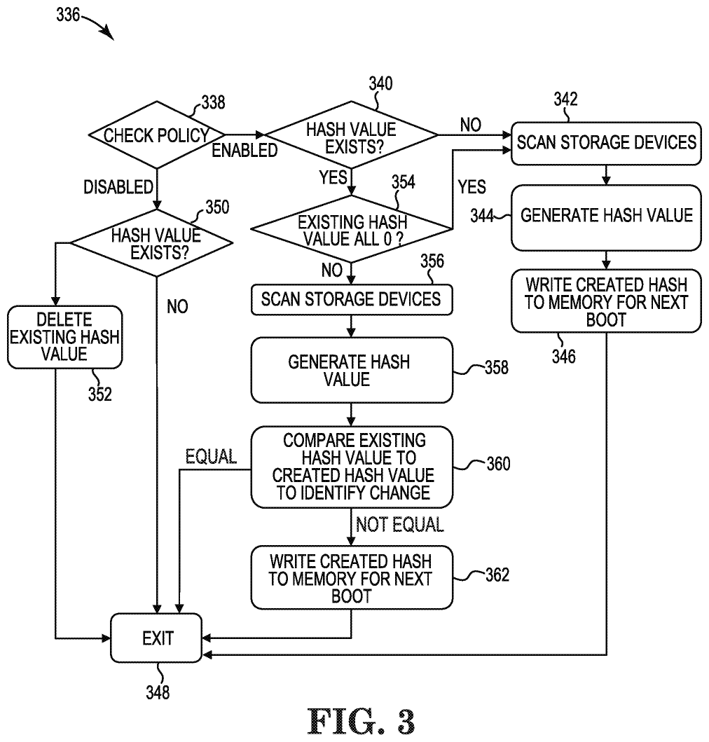

FIG. 3 illustrates an example of a process flow diagram for a process 336 of utilizing storage device hash values consistent with the present disclosure. The described components and/or operations of the process 336 may include and/or be interchanged with the described components and/or operations described in relation to FIG. 1-FIG. 2B and FIG. 4-FIG. 6.

The process 336 may be prompted by a first boot occurring at a computing device. At 338 a storage configuration comparison policy may be checked to determine whether a storage configuration comparison system is to be enabled or disabled for the computing device. If the policy check reveals that the system is disabled then, at 350, it may be determined whether a hash value from a previous boot exists at the computing device. If a hash value from a previous boot exists then, at 352, the existing hash value may be deleted. Deleting the hash value may ensure that the hash value from the previous boot is not propagated through to subsequent boots where it may no longer be relevant due to intervening storage device configuration changes. Once the existing hash value is deleted, the process may be exited at 348. If a hash value from a previous boot is determined, at 350, to not exist, then the process may be exited at 348.

In some examples, the policy check at 338 may reveal that the storage configuration comparison system is enabled. In such examples, it may be determined, at 340, whether a hash value from a previous boot exists at the computing device with the enabled policy. If a hash value from a previous boot does not exist at the computing device, then a scan of the storage devices of the computing device may be performed at 342. A storage device identification data and storage device communication path data for each storage device of the computing device may be determined from the scan. The storage device identification data and storage device communication path data for each storage device of the computing device may be recorded in a buffer of the computing device.

Then, at 344, a storage device hash value may be generated utilizing the storage device identification data and storage device communication path data for each storage device as determined from the scan. For example, the storage device identification data and storage device communication path data for the storage devices stored in the buffer may be utilized as inputs to create a corresponding hash value. The created hash value may, at 346, be written to a memory of the computing device to be utilized in a comparison at a next boot. Then the process may be exited at 348.

Alternatively, if, at 340, it is determined that a hash value from a previous boot does exist at the computing device, then it may be determined, at 354, whether the existing hash value is equal to all zeros. A hash value equal to all zeros may be indicative that no storage devices were found in a prior scan of the computing device. This is because a zero may be utilized as a default hash value. In examples, where the hash value is found to be equal to all zeros, then the scan of the storage devices of the computing device may be performed at 342. Then, at 344, a storage device hash value may be generated utilizing the storage device identification data and storage device communication path data for each storage device as determined from the scan. The created hash value may, at 346, be written to a memory of the computing device to be utilized in a comparison at a next boot. Then, at 348, the process may be exited.

If, at 354, it is determined that the existing hash value is not equal to all zeros, then the scan of the storage devices of the computing device may be performed at 356. Then, at 358, a storage device hash value may be generated utilizing the storage device identification data and storage device path data for each storage device as determined from the scan. The created hash value may, at 360, be compared to the existing hash value stored at the computing device to identify any changes that may have occurred in the storage device configurations since a previous boot whence the existing hash value was collected.

If the comparison, at 360, reveals that the created storage hash value is not equal to the existing storage hash value, then the created hash value may, at 362, be written to a memory of the computing device to be utilized as the existing hash value in a subsequent comparison conducted at a next boot. Then, at 348, the process 336 may be exited.

Alternatively, if the comparison, at 360, reveals that the created storage hash value is not equal to the existing storage hash value, then the process 336 may be exited 348 as an identical storage hash value to the created storage hash value is already saved to a memory of the computing device to be utilized as the existing hash value in a subsequent comparison conducted at a next boot.

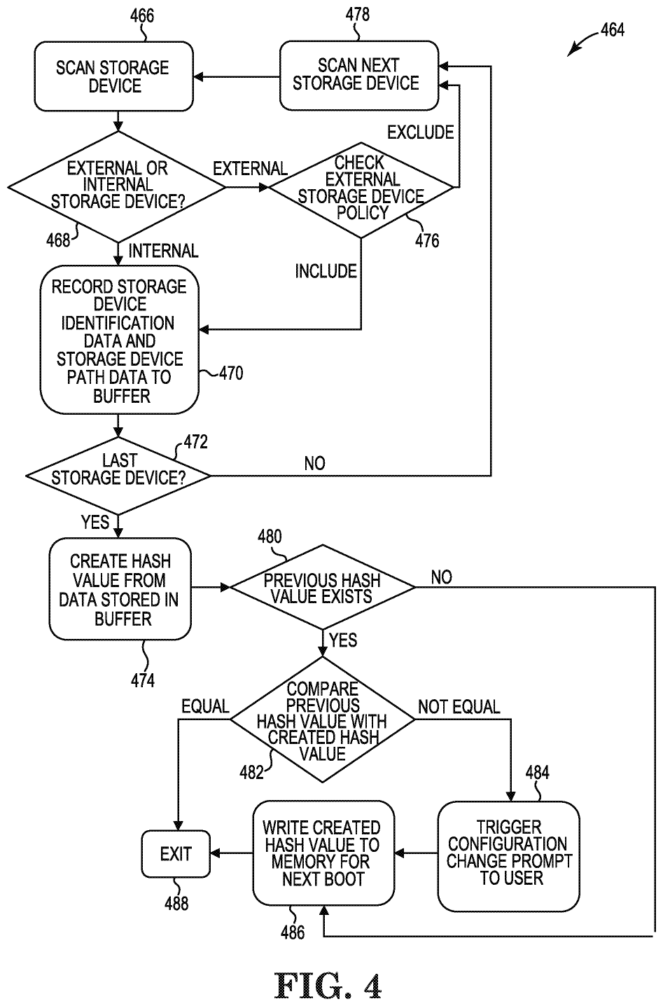

FIG. 4 illustrates an additional example of a process flow diagram for a process 464 of utilizing storage device hash values consistent with the present disclosure illustrating examples of external storage device handling and a recursive scanning of storage devices until a last storage device is scanned. The described components and/or operations of the process 464 may include and/or be interchanged with the described components and/or operations described in relation to FIG. 1-FIG. 3 and FIG. 5-FIG. 6.

The process 464 may be prompted by a first boot occurring at a computing device. At 466, the process 464 may include scanning a computing device for storage devices. Scanning for a storage device may include identifying storage devices of the computing device and identifying a corresponding storage device communication path for each storage device between a host controller and the storage device.

A determination may be made, at 468, whether a storage device identified in the storage device scan of 466 is an external storage device or an internal storage device relative to a computing device. If it is determined that the storage device is external to the computing device, then an external storage device policy may be checked at 476. The external storage device policy may specify whether an external storage device should be included in or excluded from the creation of the storage device hash value. In some examples, external storage devices, such as a flash drive, may be excluded from consideration in creating a hash value since they are so readily and regularly moveable, addable, and subtractable with respect to the computing device.

If the policy check at 476 reveals that the external storage device policy is to be excluded from the hash value, then a next storage device of the computing device may be prompted to be scanned at 478. However, if the policy check at 476 reveals that the external storage device policy is to be included for the hash value, then the storage device identification data and the storage device path data for the storage device may be saved to a buffer of the computing device at 470.

Alternatively, if it is determined at 468 that the storage device is internal to the computing device, then the storage device identification data and the storage device path data for the storage device may be saved to a buffer of the computing device at 470. At 472, it may be determined whether the storage device being analyzed is the last storage device of the computing device. If it is determined that the storage device being analyzed is not the last storage device of the computing device, then a next storage device of the computing device may be prompted to be scanned at 478. If it is determined that the storage device is the last storage device of the computing device, then, at 474, a hash value may be created from the storage device identification data and the storage device communication path data for the storage device saved to the buffer of the computing device.

A determination may be made, at 480, whether a previous hash value exists for the computing device. If it is determined that no previous hash value exists at 480, then the created hash value from 474 may be written, at 486, to the memory of the computing device to be utilized as a previous hash value in a next boot. However, if it is determined at 480 that a previous hash value does exist and is stored at the computing device, then the created hash value from 474 may be compared with the previous hash value stored at the computing device.

If the comparison at 482 reveals that the created hash value and the previous hash value are not equal, a configuration change prompt to a user may be triggered at 484. That is, if the compared hash values are not equal, this may indicate that a change has occurred to the storage device configuration since the last boot. As such, the user may receive a warning that such a change has been detected. The created hash value from 474 may be written, at 486, to a memory location of the computing device for a next boot. That is, the created hash value from 474 may be written, at 486, to the memory of the computing device to be utilized as a previous hash value in a next boot.

If the comparison at 482 reveals that the created hash value and the previous hash value are equal then the process 464 may be exited 488 as an identical previous hash value is already saved to the memory of the computing device. As such, the previous hash value may remain saved in the memory of the computing device to be utilized as a previous hash value for a next boot.

Following a write of the created hash value to a memory location of the computing device, the process 464 may be exited 488. Upon a second boot of the computing device, the hash value written in a first boot may become the previous hash value for the purposes of process 464.

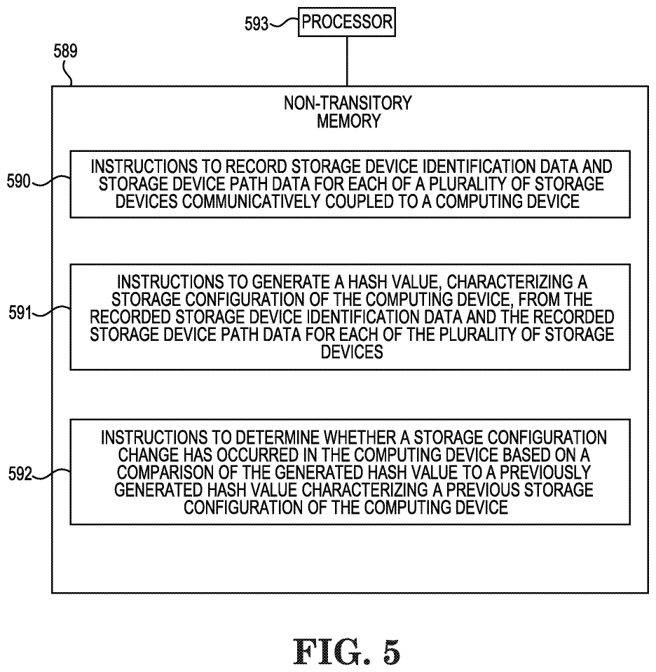

FIG. 5 illustrates an example of a non-transitory machine-readable memory and processor for utilizing storage device hash values consistent with the present disclosure. A memory resource, such as the non-transitory memory 589, may be used to store instructions (e.g., 590, 591, 592, etc.) executed by the processor 593 to perform the operations as described herein. The operations are not limited to a particular example described herein and may include and/or be interchanged with the described components and/or operations described in relation to FIG. 1-FIG. 4 and FIG. 6.

The non-transitory memory 589 may store instructions 590 executable by the processor 593 to record storage device identification data and storage device communication path data for each of a plurality of storage devices communicatively coupled to a computing device. The storage device identification data and the storage device communication path data may be recorded in a buffer of the computing device. However, in some examples, the storage device identification data and storage device communication path data for a storage device may be excluded from being recorded responsive to a determination that the storage device is an external storage device relative to the computing device.

The non-transitory memory 589 may store instructions 591 executable by the processor 593 to generate a hash value. The hash value may be generated from the recorded storage device identification data and the recorded storage device communication path data for each of the plurality of storage devices. The hash value may include a unique value characterizing a storage device configuration of the computing device. That is, the hash value may uniquely characterize the storage device communication paths and the devices within the storage device communication paths between a host controller and each of the plurality of storage devices.

The hash value may be generated responsive to a determination that the recorded storage device identification data and the recorded storage device path data for a last one of the plurality of storage devices communicatively coupled to a computing device has been recorded. For example, responsive to a determination that the storage device identification data and the storage device communication path data for a final one of the plurality of storage devices has been recorded, the hash value may be generated. In another example, responsive to a determination that there are no remaining storage devices communicatively coupled to the computing device left to be scanned and/or recorded, the hash value may be generated.

The hash value may include a single fixed-length hash value. The hash value may be generated from the recorded storage device identification data and the recorded storage device communication path data for each of the plurality of storage devices. The length of the hash value may remain fixed regardless of the amount of data per storage device and/or the amount of storage devices utilized to generate the hash.

The non-transitory memory 589 may store instructions 592 executable by the processor 593 to determine whether a storage configuration change has occurred in the computing device. The determination may be based on a comparison of the generated hash value to a previously generated hash value characterizing a previous storage device configuration of the computing device. If the generated hash value is equal to the previously generated hash value, then it may be inferred that no storage configuration changes have occurred to the computing device since the input data for that previously generated hash was collected. However, if the generated hash value is not equal to the previously generated hash value, then it may be inferred that a storage configuration change has occurred to the computing device since the input data from that previously generated hash value was collected. In examples where the generated hash value is not equal to the previously generated hash value, a user may be notified of a storage device configuration change at the computing device.

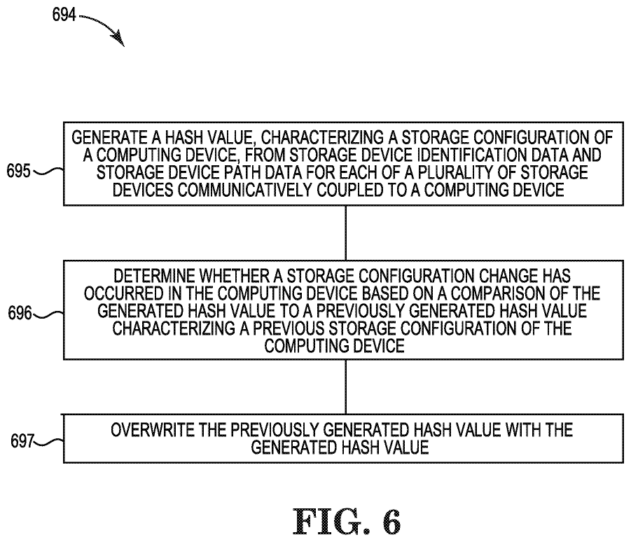

FIG. 6 illustrates an example of a method for utilizing storage device hash values consistent with the present disclosure. The described components and/or operations of method 694 may include and/or be interchanged with the described components and/or operations described in relation to FIG. 1-FIG. 5.

At 695, the method 694 may include generating a hash value. The hash value may characterize a storage configuration of a computing device. A storage configuration of a computing device may include an identification of a storage device communication path that communicatively couples a host controller of the computing device to each one of a plurality of storage devices of the computing device. The storage configuration may also include a hierarchical arrangement of the communication path that communicatively couples the host controller of the computing device to each one of the plurality of storage devices of the computing device.

The hash value may be generated from storage device identification data and storage device communication path data for each of a plurality of storage devices communicatively coupled to a computing device. For example, the alphanumeric values associated with the storage device communication path, optionally arranged in a manner that reflects their communication hierarchy, may be utilized as inputs to generate a hash value. This data may be determined for each of the storage devices by performing a scan, upon a boot of the computing device, of the plurality of storage devices communicatively coupled to the computing device and their respective communication paths. The scan may be performed in order to determine corresponding storage device identification data and a corresponding storage device communication path data for each of the storage devices.

For example, a scan may detect corresponding storage device identification data and a corresponding storage device communication path data between a 256 Gigabyte (GB) SSD storage device coupled to the computing device. For example, the SSD storage drive may be identified as an INTEL SSDPEKKW256G7-BTPY701316ZQ256D SSD. The communication path data may be identified as PCIDP[0x0]: DevNum:0x00 FuncNum:0x00 VID:0x8086 DID:0xF1A5; PCIDP[0x1]: DevNum:0x02 FuncNum:0x01 VID:0x1022 DID:0x157C; PCIDP[0x2]: DevNum:0x00 FuncNum:0x00 VID:0x0000 DID:0x0000; PCIDP[0x3]: DevNum:0x00 FuncNum:0x00 VID:0x0000 DID:0x0000; PCIDP[0x4]: DevNum:0x00 FuncNum:0x00 VID:0x0000 DID:0x0000; PCIDP[0x5]: DevNum:0x00 FuncNum:0x00 VID:0x0000 DID:0x0000; PCIDP[0x6]: DevNum:0x00 FuncNum:0x00 VID:0x0000 DID:0x0000; PCIDP[0x7]: DevNum:0x00 FuncNum:0x00 VID:0x0000 DID:0x0000; PCIDP[0x8]: DevNum:0x00 FuncNum:0x00 VID:0x0000 DID:0x0000; PCIDP[0x9]: DevNum:0x00 FuncNum:0x00 VID:0x0000 DID:0x0000; DeviceType: 0x03 PNum: 0x00, PmpNum: 0x00 when the SSD is connected via a an M.2 Key M connection.

The determined storage device identification data and the storage device communication path data for each of the plurality of storage devices may be recorded in a buffer of the computing device. Once a final one of the storage devices is scanned and its corresponding storage device identification data and storage device communication path data is saved to the buffer, the entire contents of the buffer may be utilized as an input to generate the hash value. That is, the hash value may be generated from the storage device identification data and the storage device communication path data for each of the plurality of storage devices recorded in the buffer.

For example, the communication path data for the INTEL SSDPEKKW256G7-BTPY701316ZQ256D SSD identified as PCIDP[0x0]: DevNum:0x00 FuncNum:0x00 VID:0x8086 DID:0xF1A5; PCIDP[0x1]: DevNum:0x02 FuncNum:0x01 VID:0x1022 DID:0x157C; PCIDP[0x2]: DevNum:0x00 FuncNum:0x00 VID:0x0000 DID:0x0000; PCIDP[0x3]: DevNum:0x00 FuncNum:0x00 VID:0x0000 DID:0x0000; PCIDP[0x4]: DevNum:0x00 FuncNum:0x00 VID:0x0000 DID:0x0000; PCIDP[0x5]: DevNum:0x00 FuncNum:0x00 VID:0x0000 DID:0x0000; PCIDP[0x6]: DevNum:0x00 FuncNum:0x00 VID:0x0000 DID:0x0000; PCIDP[0x7]: DevNum:0x00 FuncNum:0x00 VID:0x0000 DID:0x0000; PCIDP[0x8]: DevNum:0x00 FuncNum:0x00 VID:0x0000 DID:0x0000; PCIDP[0x9]: DevNum:0x00 FuncNum:0x00 VID:0x0000 DID:0x0000; DeviceType: 0x03 PNum: 0x00, PmpNum: 0x00 when the SSD is connected via a an M.3 Key M connection may be utilized as an input for a SHA-256 Hash to generate a SHA-256 hash value of 1075B70DBCFA2C586AAA4D5254684FF5AC634566D7FD8FB4ACFABF9B68DC0 EB4.

At 696, the method 694 may include determining whether a storage configuration change has occurred in the computing device. For example, it may be determined whether a storage configuration change has occurred in the computing device since a last boot of the computing device.

The determination of whether a storage configuration change has occurred in the computing device may be based on a comparison of the generated hash value to a previously generated hash value characterizing a previous storage configuration of the computing device. That is, each time the computing device boots, a new hash value, characterizing a storage configuration of a computing device at that moment in time, may be generated. The new hash value may be generated from the newest storage device identification data and storage device communication path data for each of a plurality of storage devices communicatively coupled to a computing device. The new hash value may be saved in the NVRAM of the computing device. Upon a subsequent boot, that new hash value may be stored in the NVRAM and may be treated as a previously generated hash value to be compared to the more recent new hash value generated upon the second boot.

The determination of whether a storage configuration change has occurred may be based on whether the generated hash value is equal to the previously generated hash value. If the hash values are equal, then it may be determined that no storage configuration change has occurred since the time when the previous hash value was generated (e.g., a prior boot). However, if the hash values are not equal it may be determined that something about the inputs (e.g., storage device identification data and the storage device communication path data) to the hash has changed since a last boot resulting in a differing hash value. As such, it may be determined that a storage configuration change has occurred since the time when the previous hash value was generated. In such examples, a prompt may be generated to warn a user that the change has occurred.

For example, an earlier scan may have detected the communication path for the INTEL SSDPEKKW256G7-BTPY701316ZQ256D SSD during a previous boot was identified as PCIDP[0x0]: DevNum:0x00 FuncNum:0x00 VID:0x8086 DID:0xF1A5; PCIDP[0x1]: DevNum:0x03 FuncNum:0x01 VID:0x1022 DID:0x157C; PCIDP[0x2]: DevNum:0x00 FuncNum:0x00 VID:0x0000 DID:0x0000; PCIDP[0x3]: DevNum:0x00 FuncNum:0x00 VID:0x0000 DID:0x0000; PCIDP[0x4]: DevNum:0x00 FuncNum:0x00 VID:0x0000 DID:0x0000; PCIDP[0x5]: DevNum:0x00 FuncNum:0x00 VID:0x0000 DID:0x0000; PCIDP[0x6]: DevNum:0x00 FuncNum:0x00 VID:0x0000 DID:0x0000: PCIDP[0x7]: DevNum:0x00 FuncNum:0x00 VID:0x0000 DID:0x0000: PCIDP[0x8]: DevNum:0x00 FuncNum:0x00 VID:0x0000 DID:0x0000; PCIDP[0x9]: DevNum:0x00 FuncNum:0x00 VID:0x0000 DID:0x0000; DeviceType: 0x03 PNum: 0x00, PmpNum: 0x00 when the SSD is connected via a PCIe x16 connection. That earlier scan may have been utilized as an input for a SHA-256 Hash to generate a SHA-256 hash value of 6FB0CCB5DCFF16A13F4A4457498BA6362EA40043194137F95F4C566AC3D1F29 9.

Alternatively, an earlier scan may have detected the communication path for the INTEL SSDPEKKW256G7-BTPY701316ZQ256D SSD during a previous boot was identified as PCIDP[0x0]: DevNum:0x00 FuncNum:0x00 VID:0x8086 DID:0xF1A5; PCIDP[0x1]: DevNum:0x00 FuncNum:0x00 VID:0x1022 DID:0x43B4; PCIDP[0x2]: DevNum:0x00 FuncNum:0x02 VID:0x1022 DID:0x43B2; PCIDP[0x3]: DevNum:0x02 FuncNum:0x04 VID:0x1022 DID:0x157C; PCIDP[0x4]: DevNum:0x00 FuncNum:0x00 VID:0x0000 DID:0x0000; PCIDP[0x5]: DevNum:0x00 FuncNum:0x00 VID:0x0000 DID:0x0000; PCIDP[0x6]: DevNum:0x00 FuncNum:0x00 VID:0x0000 DID:0x0000; PCIDP[0x7]: DevNum:0x00 FuncNum:0x00 VID:0x0000 DID:0x0000; PCIDP[0x8]: DevNum:0x00 FuncNum:0x00 VID:0x0000 DID:0x0000; PCIDP[0x9]: DevNum:0x00 FuncNum:0x00 VID:0x0000 DID:0x0000; DeviceType: 0x03 PNum: 0x00, PmpNum: 0x00 when the SSD is connected via a PCIe x1 connection. That earlier scan may have been utilized as an input for a SHA-256 Hash to generate a SHA-256 hash value of 361A6906293F23C2A9AFFC14EC40CEDB329A44DFE0DBEDFCDAA3E3C815932 148.

Regardless of which of the above described examples is considered, a comparison of the resulting hash values reveals that the hash values do not match across the boots. As such, it may be determined that a storage configuration change has occurred between the boots.

At 697, the method 694 may include overwriting the previously generated hash value with the newly generated hash value. For example, the newly generated hash value may overwrite the previously generated hash value in the NVRAM of the computing device 102. As such, the newly generated hash value will be persisted through to a next boot of the computing device and the previously generated hash value will be eliminated. As such, the hash value stored in the NVRAM of the computing device will be reflective of a most recent storage device configuration detected at the computing device 102.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure. Further, as used herein, “a plurality of” an element and/or feature can refer to more than one of such elements and/or features.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure and should not be taken in a limiting sense.

What is claimed:

1. A system, comprising:
a processor; and
a non-transitory machine-readable storage medium to store instructions executable by the processor to:
record, responsive to a first boot of a computing device, storage device identification data and storage device communication path data for a storage device of the computing device,
generate a storage device hash value, to characterize a storage configuration of the computing device, from the recorded storage device identification data and the recorded storage device communication path data, and
store the storage device hash value to be compared to a subsequently generated storage device hash value to characterize an updated storage configuration of the computing device at a second boot of the computing device.

2. The system of claim 1, wherein the storage device identification data includes at least one of a model number of the storage device and a serial number of the storage device.

3. The system of claim 1, wherein the storage device communication path data includes at least one of a device identification (DID) of a bridge in a storage device communication path between a host controller of the computing device and the storage device and a vendor identification (VID) of the bridge in the storage device communication path between the host controller of the computing device and the storage device.

4. The system of claim 1, wherein the storage device communication path data includes, at least one of a device identification (DID) of a storage controller in a storage device communication path between a host controller of the computing device and the storage device and a vendor identification (VID) of the storage controller in the storage device communication path between the host controller of the computing device and the storage device.

5. The system of claim 1, wherein the storage device communication path data includes input/output (I/O) port connection pairing data for the storage device.

6. The system of claim 1, including instructions executable by the processor to:
perform, responsive to a determination that a storage configuration comparison policy for the computing device is enabled, a comparison of the generated storage device hash value to a previously generated storage device hash value stored for the computing device; and
overwrite, responsive to a completion of the comparison, the previously generated hash value with the generated hash value.

7. The system of claim 1, wherein the hash value is stored to a non-volatile random-access memory (NVRAM) accessible to firmware of the computing device upon the second boot in order to perform the comparison to the subsequently generated hash value.

8. A non-transitory machine-readable storage medium comprising instructions executable by a processor to:
record storage device identification data and storage device path data for each of a plurality of storage devices communicatively coupled to a computing device;
generate a hash value, to characterize a storage device configuration of the computing device, from the recorded storage device identification data and the recorded storage device path data for each of the plurality of storage devices; and
determine whether a storage configuration change has occurred in the computing device based on a comparison of the generated hash value to a previously generated hash value to characterize a previous storage configuration of the computing device.

9. The non-transitory machine-readable storage medium of claim 8, wherein the hash value is generated responsive to a determination that the recorded storage device identification data and the recorded storage device path data for a last one of the plurality of storage devices communicatively coupled to a computing device have been recorded.

10. The non-transitory machine-readable storage medium of claim 8, wherein the hash value is a single fixed-length hash value generated from the recorded storage device identification data and the recorded storage device path data for each of the plurality of storage devices.

11. The non-transitory machine-readable storage medium of claim 8, including instructions executable by the processor to exclude the storage device identification data and storage device path data for a storage device of the plurality of storage devices from being recorded responsive to a determination that the storage device of the plurality of storage devices is an external storage device relative to the computing device.

12. The non-transitory machine-readable storage medium of claim 8, including instructions executable by the processor to notify a user of a storage configuration change at the computing device based on a determination that the generated hash value is not equal to a previously generated hash value.

13. A method, comprising:
generating a hash value, characterizing a storage configuration of a computing device, from storage device identification data and storage device path data for each of a plurality of storage devices communicatively coupled to a computing device;
determining whether a storage configuration change has occurred in the computing device based on a comparison of the generated hash value to a previously generated hash value characterizing a previous storage configuration of the computing device; and
overwriting the previously generated hash value with the generated hash value.

14. The method of claim 13, including scanning, upon a boot of the computing device, each of the plurality of storage devices communicatively coupled to the computing device to determine a corresponding storage device identification data and a corresponding storage device path data.

15. The method of claim 13, including:
recording the determined storage device identification data and the storage device path data for each of the plurality of storage devices into a buffer of the computing device; and
generating the hash value from the storage device identification data and the storage device path data for each of the plurality of storage devices recorded in the buffer.
